(19) United States
(12) Patent Application Publication
(10) Pub. No.: US 2011/0055437 A1
(43) Pub. Date: Mar. 3, 2011

(54) MOBILE COMMUNICATION DEVICE WHICH CAN SERVE AS INPUT DEVICE FOR COMPUTER

(76) Inventor: Wei Hsu, Chung Ho City (TW)

(21) Appl. No.: 12/547,187

(22) Filed: Aug. 25, 2009

(51) Int. Cl. G06F 3/00

(52) U.S. Cl. 710/30

(57) ABSTRACT

The present invention discloses a mobile communication device which can serve as an input device for a computer, the mobile communication device including a control circuit; a command input device coupled to the control circuit to input information; and a transcoder coupled to the control circuit to transform a first command signal from the command input device into a second command signal readable to a computer.

### FIELD OF THE INVENTION

The present invention relates to a mobile communication device, and more particularly to a mobile communication device which can serve as an input device for a computer.

### BACKGROUND OF THE INVENTION

In recent years, information industries develop very fast. Various kinds of slim computers and notebooks are continuously developed. The manufacturers tend to focus on the slimness of computers. The users prefer to buy small size computers to meet the demands of surfing the net and real-time chatting. Therefore, slime computers, for example EeePC made by ASUS, are hot goods on the market. However, the sizes of traditional personal computers are not reduced. Although the hosts of the personal computers have been developed into smaller sizes and still can contain all hardware, the sizes of the keyboards of the traditional personal computers are not reduced, such that it is heavy and hard for the users to transport or carry the traditional personal computers.

For example, a traditional keyboard structure includes a base, a light guiding element, a membrane circuit board, a key assembly and a light-emission element. The light guiding element is disposed on the base. The membrane circuit board is disposed on the light guiding element. The key assembly is disposed on the membrane circuit board and composed of a key cap and a resilient element between the key cap and the membrane circuit board. The light-emission element is adjacent to the light guiding element and disposed under the membrane circuit board. The light-emission element outputs light to the resilient element and key cap through the light guiding element.

Since the aforementioned traditional keyboard structure has a length equal to the length of the case of the host and is quite large, the traditional keyboard suffers from the aforementioned problem of not being suitable to be transported or carried by the user. Moreover, the traditional keyboard can not be easily received because of the large size thereof.

Therefore, there is still a demand for a keyboard-like input device which can be carried conveniently to solve the aforementioned problems of the traditional keyboards.

### SUMMARY OF THE INVENTION

In view of the aforementioned problems of not being suitable to be carried, transported or received, the present invention discloses a mobile communication device which can serve as an input device for a computer and is suitable to be carried.

In one aspect of the present invention, the present invention discloses a mobile communication device which can serve as an input device for a computer, the mobile communication device including a control circuit; a command input device coupled to the control circuit to input information; and a transcoder coupled to the control circuit to transform a first command signal from the command input device into a second command signal readable to a computer. The mobile communication device further includes a mobile communication device output interface coupled to the transcoder to further couple with the computer.

The mobile communication device output interface includes a wired transmission interface or a wireless transmission interface. The wired transmission interface includes a USB (universal serial bus) or an IEEE1394 interface. The USB (universal serial bus) includes a Type A USB (universal serial bus), a Type B USB (universal serial bus), a Type Mini-A USB (universal serial bus), a Type Mini-B USB (universal serial bus) or a Type Mini-AB USB (universal serial bus). The wireless transmission interface includes an IR (infrared) standard module or a BLUETOOTH standard module.

One advantage of the present invention is that the mobile communication device which can serve as the input device for the computer can enable the user to utilize a small size mobile communication device to input any information without a large traditional keyboard.

Another advantage of the present invention is that the mobile communication device which can serve as the input device for the computer can be easily carried or transported by the user and can be conveniently received by the user because of the small size thereof.

These advantages will become apparent from the following description of preferred embodiments taken together with the accompanying drawings and the appended claims.

### BRIEF DESCRIPTION OF THE DRAWINGS

The aforementioned elements, the features and the advantages of the present invention may be better understood by reading the following detailed description and the accompanying drawings, wherein:

FIG. 1 is a block diagram of the mobile communication device which can serve as the input device for the computer in accordance with the present invention; and

FIG. 2 illustrates the example of application of the mobile communication device which can serve as the input device for the computer of the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

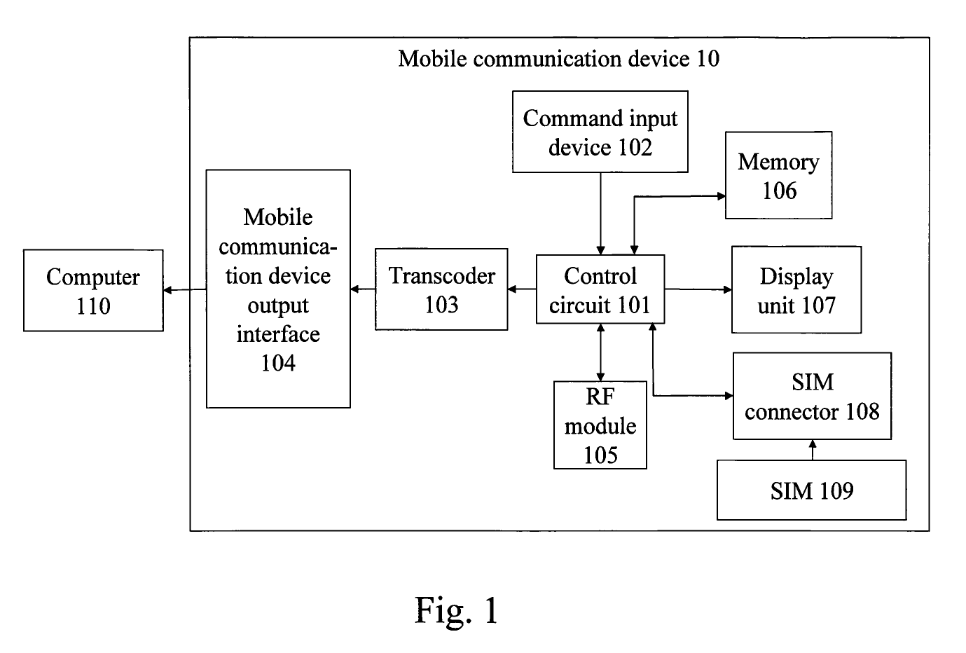

In one embodiment of the present invention, the present invention discloses a mobile communication device which can serve as an input device for a computer, for example a mobile phone or any other types of mobile communication devices with a keypad or a pointing device. As shown in FIG. 1, the mobile communication device which can serve as the input device for the computer 10 includes a control circuit 101, a command input device 102, for example a keypad or a pointing device, a transcoder 103, a mobile communication device output interface 104, a radio frequency (RF) module 105, a memory 106, a display unit 107, a subscriber identity module (SIM) connector 108 and a subscriber identity module 109. As shown in FIG. 1, the command input device 102, for example the keypad, the transcoder 103, the radio frequency (RF) module 105, the memory 106, the display unit 107 and the subscriber identity module (SIM) connector 108 are respectively coupled to the control circuit 101. The transcoder 103 is coupled to the mobile communication device output interface 104 to be further coupled to a computer 110. The computer 110 includes a personal computer, a notebook, a slim computer and an easy personal computer (easy PC).

In one embodiment of the present invention, the command input device 102, for example the keypad, includes keys with numbers, English letters and Chinese letters to input texts or numbers. Because of the difference between encoding methods of the mobile communication device and the computer, in one embodiment, the present invention includes a transcoder 103 to transform the command signals from the command input device 102, for example the keypad, of the mobile communication device 10 into command signals readable to the computer 110. It should be noted that the transcoder 103 may performed in software or hardware. In one embodiment, the mobile communication device output interface 104 may be a wired or wireless transmission interface including but not being limited to BLUETOOTH standard module, IR (infrared) standard module, USB (universal serial bus) and IEEE1394 interface. USB (universal serial bus) includes but is not limited to Type A USB (universal serial bus), Type B USB (universal serial bus), Type Mini-A USB (universal serial bus), Type Mini-B USB (universal serial bus) and Type Mini-AB USB (universal serial bus). The radio frequency (RF) module 105 includes an antenna, a receiving and transmitting device, a modem, and a DSP (Digital signal processor), a codec and a digital-analog converter to receive and transmit communication signals. The memory 106 is utilized to store different information, for example contact phone numbers, call logs, messages, etc. The display unit 107 is utilized to display the aforementioned information, for example contact phone numbers, call logs, messages, etc, in the form of texts or images. The subscriber identity module (SIM) connector 108 is utilized to connect the subscriber identity module (SIM) 109.

As aforementioned, the command signals from the command input device 102, for example the keypad, of the mobile communication device 10 are transformed into computer-readable command signals, so as to input information into the computer 110 coupled through the mobile communication device output interface 104. Therefore, the mobile communication device 10 outputs the transformed command signals of the command input device 102 to the computer 110 through the transcoder 103 and the mobile communication device output interface 104 to serve as an input device for the computer 110. In one embodiment of the present invention, the transcoder 103 of the present invention may be embedded in the mobile communication device 10 as shown in FIG. 1, or be disposed outside of the mobile communication device 10. Therefore, the present invention provides a mobile communication device 10 which can serve as an input device for a computer.

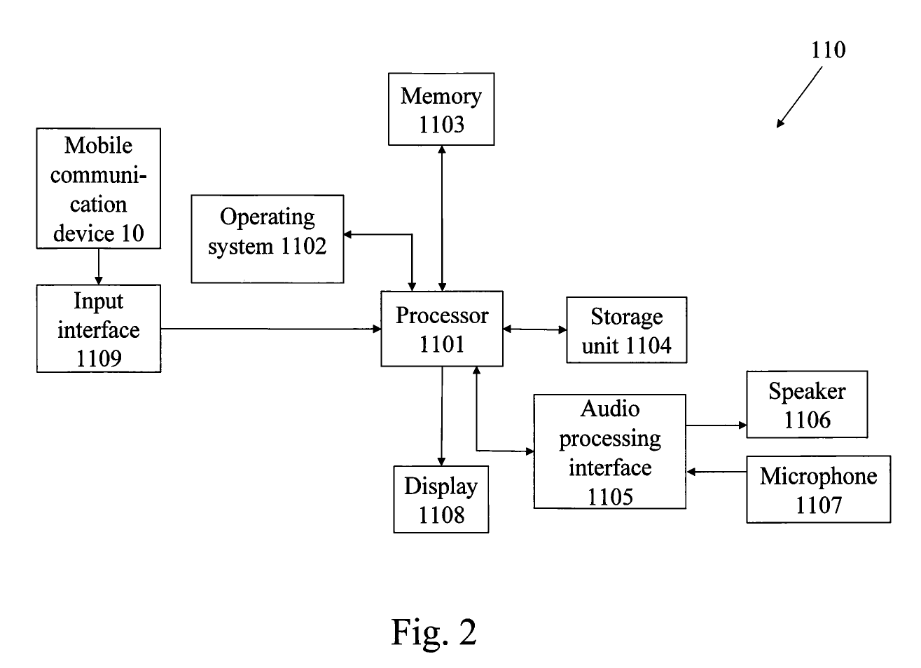

With reference to FIG. 2, the computer 110 is taken as an example in the following descriptions to illustrate the present invention. In one embodiment of the present invention, the computer 110 primarily includes a processor 1101, an operating system 1102, a memory 1103, a storage unit 1104, an audio processing interface 1105, a speaker 1106, a microphone 1107, a display 1108 and an input interface 1109. The operating system 1102, the memory 1103, the storage unit 1104, the audio processing interface 1105, the display 1108 and the input interface 1109 are respectively coupled to the processor 1101. The operating system 1102 is utilized to provide an operating interface for the user to interact with the system. The memory 1103 is utilized to store digital audio signals, digital video signals, digital data signals or any other information, and includes flash memory, random access memory (RAM) or any other types of known memories. The storage unit 1104 is utilized to store digital audio signals, digital video signals, digital data signals or any other information, and includes a hard disk, for example an ATA (Advanced Technology Attachment) hard disk, a SATA (Serial Advanced Technology Attachment; Serial ATA) hard disk, a SCSI (Small Computer System Interface) hard disk and a SAS (Serial Attached SCSI) hard disk.

Moreover, the audio processing interface 1105 is utilized to process audio signals, for example transform digital audio signals into analog audio signals and vice versa, so as to receive analog audio signals from the microphone 1107 or output analog audio signals to the speaker 1106. The display 1108 is utilized to display different information in the form of texts or images. The input interface 1109 includes a BLUETOOTH standard module, IR (infrared) standard module, USB (universal serial bus), for example Type A USB (universal serial bus), Type B USB (universal serial bus), Type Mini-A USB (universal serial bus), Type Mini-B USB (universal serial bus) and Type Mini-AB USB (universal serial bus), and IEEE1394 interface. The input interface 1109 is compatible to the mobile communication device output interface 104 of the mobile communication device 10 to receive the transformed command signals of the command input device 102 outputted from the mobile communication device 10. The operating system 1102 of the computer 110 can recognize the transformed command signals of the command input device 102 because the command signals of the command input device 102, for example the keypad, of the mobile communication device 10, are transformed by the transcoder 103. Therefore, the computer 110 can utilize the input interface 1109 to receive the transformed command signals of the command input device 102 outputted from the mobile communication device 10, so as to be further input with information with the cooperation of the operating system 1102.

As aforementioned, the present invention provides the mobile communication device 10 which can serve as the input device for the computer by utilizing the transcoder 103 to transform the command signals of the command input device 102, for example the keypad. Therefore, the mobile communication device 10 can input information, for example texts or numbers, into the computer 110, for example a personal computer, a notebook, an easy personal computer (easy PC) and a slim computer, to replace the traditional keyboard, such that the user can input information into the computer much easier. Furthermore, the user can utilize the small size mobile communication device which can serve as the input device for the computer of the present invention to input any information at any time anywhere without the need of the large traditional keyboard because the mobile communication device is lighter than the traditional keyboard and can be easily carried.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A mobile communication device, comprising:
a control circuit;
a command input device coupled to said control circuit to input information; and
a transcoder coupled to said control circuit to transform a first command signal from said command input device into a second command signal readable to a computer.

2. The mobile communication device of claim 1, further comprising a mobile communication device output interface coupled to said transcoder, said mobile communication device output interface is utilized to couple with said computer.

3. The mobile communication device of claim 2, wherein said mobile communication device output interface comprises a wired transmission interface.

4. The mobile communication device of claim 3, wherein said wired transmission interface comprises a USB (universal serial bus).

5. The mobile communication device of claim 4, wherein said USB (universal serial bus) comprises a Type A USB (universal serial bus) or a Type B USB (universal serial bus).

6. The mobile communication device of claim 4, wherein said USB (universal serial bus) comprises a Type Mini-A USB (universal serial bus), a Type Mini-B USB (universal serial bus) or a Type Mini-AB USB (universal serial bus).

7. The mobile communication device of claim 3, wherein said wired transmission interface comprises an IEEE1394 interface.

8. The mobile communication device of claim 2, wherein said mobile communication device output interface comprises a wireless transmission interface.

9. The mobile communication device of claim 8, wherein said wireless transmission interface comprises a BLUETOOTH standard module.

10. The mobile communication device of claim 8, wherein said wireless transmission interface comprises an IR (infrared) standard module.

11. The mobile communication device of claim 1, wherein said command input device comprises a keypad.

12. The mobile communication device of claim 1, wherein said command input device comprises a pointing device.
